(19) United States
(12) Patent Application Publication
(10) Pub. No.: US 2008/0311357 A1
(43) Pub. Date: Dec. 18, 2008

(54) LAMINATE CONSTRUCTION CONTAINING DISCONTINUOUS METAL LAYER

(75) Inventors: Donna Millette, Chester, NH (US); Brian Porter, Milton, NH (US); Robert O. Tibbetts, Alton, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: COLLINS & AIKMAN CORPORATION, Southfield, MI (US)

(21) Appl. No.: 11/967,695

(22) Filed: Dec. 31, 2007

Related U.S. Application Data
(60) Provisional application No. 60/882,852, filed on Dec. 29, 2006.

(51) Int. Cl. B32B 3/02

(52) U.S. Cl. 428/201

(57) ABSTRACT

A sheetstock having a bright metallic appearance, especially useful as signage, badging, automotive trim and appliance trim, is provided by applying an island coating system on the second surface of a transparent or translucent sheetstock. The island coating system may comprise a clear layer, a discontinuous metal layer and a backing layer. The sheetstock and/or clear layer may be colored, printed upon or contain decorative particles to enhance the appearance.

### CROSS-REFERENCE TO RELATED APPLICATIONS

The present application claims the benefit of the filing date of U.S. Provisional Application Ser. No. 60/882,852, filed Dec. 29, 2006, the teachings of which are incorporated herein by reference.

### FIELD

This disclosure relates generally to sheetstock having a bright metallic appearance and, more particularly, to transparent or translucent sheetstock which has been coated on a second surface with an island coating system.

### BACKGROUND

A body of art has been developed around the deposition of a discontinuous metal layer, particularly indium and it's alloys, on a flexible substrate to provide bright, reflective trim articles such as grills, door handles, wheels, etc. for the automotive industry. These articles were bright and reflective, yet capable of being impacted or flexed without cracking. The discontinuous metal of indium was deposited on a urethane based primer and/or base coat and then covered with a transparent topcoat to form an island coating system which encapsulated and protected the metal islands. U.S. Pat. Nos. 4,407,871; 4,431,711 and 4,713,143, assigned to assignee of the present disclosure and incorporated herein by reference, relate to metallizing of plastic articles and more particularly to the structure and spacing of discrete metal islands used to metallize, rather than a continuous metal film. The metallizing is performed utilizing the island coating system as detailed in the aforesaid patents. The system includes generally spray depositing sequentially onto a substrate a primer coating layer, a basecoat coating layer, a metallizing layer and a topcoat layer. In addition to proper deposition of the coating layers, the appearance and performance of the commercial product, the conductivity of the metal layer, the corrosion resistance of the metal layer and/or the adhesion of the topcoat all relate to the structure and spacing of the islands. The above referenced patents provide further teachings related to nucleation and film growth to the desired island structure and spacing that may achieve these ends. In U.S. Pat. No. 5,290,625, assigned to the assignee of the present disclosure and incorporated herein by reference, the above process is applied to aluminum parts. In a co-pending application, U.S. Pat. No. 5,468,518, assigned to the assignee of the present disclosure and incorporated herein by reference, the coating layers are modified to form a combined primer/basecoat layer. The underlying combined primer/basecoat can include a pigment to provide a colored metallic appearance as disclosed in U.S. Pat. No. 5,320,869 issued Jun. 14, 1994 and assigned to assignee of the present disclosure and incorporated herein by reference. In another co-pending application, U.S. Pat. No. 5,464,661, assigned to the assignee of the present disclosure and incorporated herein by reference, the technology for coating layer deposited is improved to allow film builds of 1.5 to 2.0 mils, eliminating significant coating irregularities. The island coating system may be deposited by spraying the polymeric constituents of the primer layer, basecoat layer and topcoat layer in organic solvent carries such as glycol ethers, glycolether acetates, aromatic hydrocarbons and dibasic esters. These solvent carriers may pose a waste disposal problem increasing the cost of production significantly, a flammability hazard, as well as requiring significant flash and cure times. As described in U.S. Pat. Nos. 5,711,993; 6,361,854; 5,989,418 and 6,238,776 the solvents may be reduced or eliminated, while still maintaining the aesthetic properties of the metallized appearance and a significant savings in time and therefore increased production, improved safety, as well as ease of waste disposal. Additionally, with the elimination of organic solvents the range of substrates that can be metallized may be increased. In general, the step of spray depositing may be done for batch processing while the parts are being rotated as described in U.S. Pat. No. 5,284,679 issued Feb. 8, 1994 and assigned to the assignee of the present disclosure, and incorporated herein by reference. However, the use of rotation is not practical when dealing with substrates that are thin sheets such as thin extruded polymers, cellulose based materials and textiles. These thin gauge sheets or sheetstocks require different handling and for high speed production it may be useful to be able to have continuous in-line processing. This is described in U.S. Pat. No. 6,238,776 and incorporated herein by reference. It has been found that the application of the island coating system in a reverse order onto the second surface of a transparent or translucent sheetstock may provide an improvement in the durability of sheetstock coated on the first surface with an island coating system and may further expand the capabilities for decorating bright reflective sheetstock

### SUMMARY

Improved intercoat adhesion, weatherability and impact resistance as well as an expanded capability to decorate a transparent or translucent sheetstock may be provided by applying a island coating system, in reverse order, to the second (inner or non-exposed) surface of the sheetstock. A transparent or translucent polymeric sheetstock may be coated on it's second (inner or non-exposed) surface with a transparent coating followed by the deposition of a discontinuous metallic layer, followed by the application of a backing layer. The sheetstock and/or transparent topcoat may be tinted, dyed, colored or printed upon to produce a desired pattern or visual effect. The layer of discontinuous metal, preferably indium and it's alloys, may provide a bright, reflective layer to further enhance appearance. The backing layer may encapsulate the metal islands and provide a protective back surface for the flexible laminate.

Improved intercoat adhesion and depth of image maybe provided by the above-described construction for articles that may find use in numerous trim applications in the apparel, badging, signage, appliance and automotive industry.

### DESCRIPTION OF THE DRAWINGS

These and other objects, features and advantages of the disclosure will become apparent upon consideration of the description of the disclosure and the appended drawings in which:

FIG. 1 is a cross sectional view of a flexible reflective laminate construction in the prior art.

FIG. 2 is a cross sectional view of a flexible reflective laminate construction according to the present disclosure.

### DETAILED DESCRIPTION

Brightly reflective, clear or colored sheetstock may find use in a variety of industries as decorative trim. The ability to flex without cracking, yet provide a near-mirror image metallic appearance may find numerous uses. In addition, the presence of a discontinuous metal layer as the reflective surface may allow the sheetstock to be diecut, machine washed, stitched, thermally bonded and otherwise processed without damage.

To improve the durability of such flexible bright metallic appearing laminates, an island coating system may be applied, in reverse order, to the second (inner or non-exposed) surface of a transparent or translucent sheet of material. This construction also may provide additional decorating options as either or both of the transparent sheetstock and transparent coating maybe tinted, dyed, colored or printed upon to further distinguish the appearance of the resultant laminate.

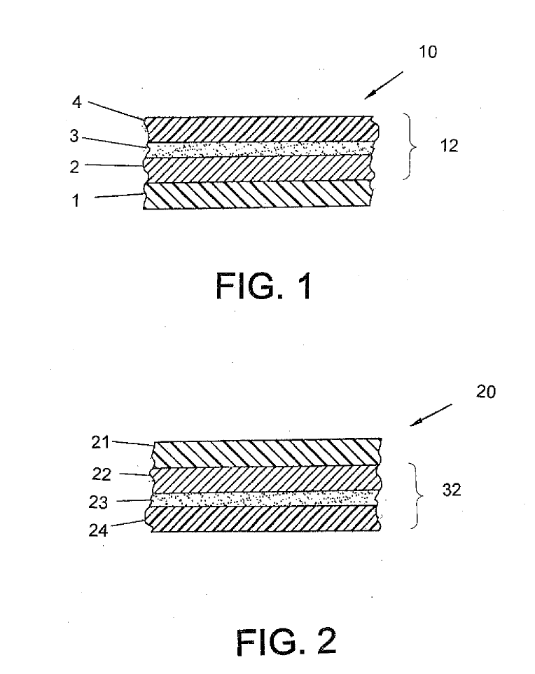

An island coating system to provide a bright, reflective coating for a flexible substrate is disclosed in U.S. Pat. No. 4,431,711 assigned to the assignee of the present disclosure and included herein by reference in its entirely. FIG. 1 illustrates a cross-section of such a construction. The construction 10 may include a substrate layer 1, preferably somewhat flexible, to take full advantage of the flexible properties of the island coating system, although rigid materials such as wheels and even aluminum trim have been coated.

The substrate layer 1 may be a sheetstock material of about 0.020 to about 0.060 inches in thickness, comprising a polymeric material. Onto the first surface of such a substrate layer 1 an island coating system 12 maybe applied. The island coating system may then be applied as taught in U.S. Pat. Nos. 4,407,871; 4,431,711; 4,713,143; 5,290,625 and 6,361,854. The island coating system includes generally a first coating layer of either a combined primer/basecoat layer, or separately applied primer and basecoat layers, followed by a metallizing layer and an encapsulating topcoat layer. The prior art teaches that each coating layer contains film forming polymers as disclosed in the above referenced patents.

As shown in FIG. 1, the island coating system may comprise a primer/basecoat layer 2, metal layer 3 and protective topcoat 4. The primer or combined primer/basecoat layer 2 may be applied to the substrate layer 1, to provide an adhesive and smooth surface for the application of a discontinuous layer of metal 3. The primer or combined primer/basecoat layer 2 may comprise a urethane polymer and be colored to enhance the appearance of the metal layer 3. The discontinuous metal layer 3 maybe deposited on the primer/basecoat layer 2 by, for instance, vacuum metallization, ion plating, electron beam evaporation, sputtering, and other equivalent processes using metals such as indium to form discrete islands of metal which provide a light reflective surface capable of being flexed without cracking and which don't conduct electricity. Typically the metal may be applied at a thickness of about 600 to about 1000 Angstroms. The thicknesses of the layers in FIG. 1 may not be indicative of the actual thicknesses employed (for instance, the polymeric coating layers may be about 1-2 mils in thickness, while the substrate may be about 20 to 60 mils and the metal layer around 600-1000 Angstroms).

A transparent topcoat layer 4 may then be applied onto the metal layer 3 to encapsulate the islands of metal and provide abrasion resistance and weathering protection. Indium is a corrosion prone metal, which requires surface protection. In the resultant laminate 10, the durability maybe a function of the type, thickness and additive package used in the topcoat layer 4. The thickness of that layer 4 further defines the depth of image of the laminate.

To provide improved depth of image (the appearance that the reflective surface lies deep below the outer surface) and additional decorating options, a construction 20 as shown in cross-section in FIG. 2 has been developed.

Here the outer layer 21 comprises a sheetstock which maybe transparent or translucent and capable of transmitting at least some light reflected from a metallic layer coated therebehind. The sheetstock may comprise any transparent or translucent polymeric material, preferably one having an elongation above 30%. Particularly preferred sheetstock materials may comprise, including but not limited to, thermosetting materials and elastomeric materials such as thermoset polyurethane, and thermoplastic materials, such as polyolefins (such as polyethylene, polypropylene and polybutylene), polyvinyl chloride, ionomers, polyesters, polyester elastomers, polycarbonates, polymethyl-methacrylates, copolyester alloys, cyclic olefin copolymers, poly-4-methyl-1-pentene, polysulphones, allyl diglycol carbonates, allyl esters, styrene-acrylonitrile blends and polystyrene.

Onto the back, or second surface, of this outer sheetstock layer 21, an island coating system 32 maybe applied, in reverse order, to provide the bright reflective appearance combined with improved durability and depth of image.

The island coating system 32 may comprise a first transparent coating layer 22. This layer may further comprise a relatively light stable polymeric layer, preferably an aliphatic urethane polymer. Either of the sheetstock layer 21 and/or the transparent coating layer 22 may include tints, dyes, pigments or particles to enhance the appearance of the laminate construction 20 by adding color, light dispersive qualities, etc. In addition, the second surface of either or both of the sheetstock layer 21 and transparent coating layer 22 may have patterns, indicia, logo's etc. printed, engraved or otherwise applied or transferred thereupon to decorate the construction 20. This coating layer may generally be applied by spraying to a dry thickness of about 0.001 to about 0.005 inches.

A discontinuous layer 23, of preferably a corrosion-prone metal, may be deposited onto the exposed surface of the transparent coating layer 22 to provide a bright reflective quality to the construction 20. The metals that may be used to form the layer of metallic islands are metals, or surface oxidized metals, that may give a bright surface. Suitable metals are corrosion-prone metals including tantalum, copper, silver, nickel, chromium, tin and aluminum and alloys thereof, and the like. Preferably, the metallic islands contain indium, indium alloys and/or indium oxides.

The layer of metallic islands may be formed by depositing metal on the substrate, or coated substrate, by thermal evaporation, sputtering, ion plating, induction heating, electron beam evaporation and like methods. More uniform coverage is obtained, particularly around corners, edges or recesses if the metallization occurs in a chamber containing an inert gas such as argon.

Finally, a backing layer 24 maybe applied over the discontinuous metal layer 23 to at least partially encapsulate the metal islands and provide protection against abrasion. This layer 23 maybe applied by spraying and may comprise a urethane based coating of about 0.001-0.002 inches in thickness. The coating maybe colored to achieve a desired appearance of the laminate construction 20. This layer 23 may further act as an adhesive layer for additional layers to adhere to in the case where the laminate construction 20 maybe formed to shape and backed by a substrate, for instance by injection molding.

The coating compositions, whether they be basecoat and/or transparent coating layer may be cured at a temperature that is high enough to completely cure the coating material but low enough such that the coating does not burn or significantly discolor. Typically, the coating may be cured at a temperature range of approximately 150-375° F. for a period of time of about 10 minutes to about 70 minutes. The coating may preferably be cured at a temperature between about 250° F. to 300° F. Preferably, the coating thickness is between 0.0015 and 0.0025 inches.

A method for applying a prime coat, basecoat, combined primer/basecoat or transparent coating layer, to a substrate or a layer of metallic islands, is described in U.S. Pat. Nos. 4,407,871; 4,431,711 and 5,468,518 which are incorporated herein by reference. Typical methods may include spray coating, dip coating, flow coating, roller and knife-over-roll coating.

Generally, the coating may be applied in an organic solvent system wherein the organic solvent(s) may comprise about 40% to about 90% of the weight of the pre-cured coating composition. The urethane resin typically may be about 10% to 50% by weight of the pre-cured coating composition.

A wide variety of organic solvents may be utilized for the coating compositions, such as aromatic hydrocarbons, alkylesters, alcohols, ketones and dialkylethers.

The application of the coating system described herein is preferably performed by an airless spray gun. The coatings are applied to the substrate at ambient temperature and pressure.

In the application of the coating system to the substrate whether as a basecoat, primer coat or top coat, inorganic carriers, such as liquid carbon dioxide, can be substituted for a portion or all of the organic solvent carriers. This method for applying a coating with a reduced amount of organic solvent is described in U.S. Pat. No. 5,464,661, which is incorporated herein by reference. In addition, the transparent coating layer may comprise a polyurethane which may include an epoxy silane or aminosilane as disclosed in U.S. Pat. Nos. 6,416,847 and 6,440,541, respectively, commonly assigned to the assignee of the present disclosure and included herein by reference. Further, the transparent coating layer 22, and/or the backing layer 24 of the present disclosure may contain a radiation curable film former according to U.S. Pat. No. 5,711,993, commonly assigned to the assignee of the present disclosure and included herein by reference.

The laminate construction 20 of the present disclosure may be formed to have a final thickness of about 0.010 inches to about 0.500 inches, governed primarily by the thickness of the sheetstock layer 21.

It is contemplated that the sheetstock layer 21 may be prepared by such processes as extrusion or calendaring to form a transparent or translucent sheet of polymeric material which allows at least some light to pass through the sheet. In addition, the application of the various layers of the island coating system to the sheetstock may take place in a continuous or semi-continuous manner via in-line processing such as reel to reel.

By placing the island coating system 32 on the second surface of the sheetstock 21, improvements in inter-coat adhesion, particularly for the metal layer, may be realized. In addition, any color generating additives, such as tints or dyes that maybe included in the transparent coating layer 22 will be further protected from sunlight degradation by the presence of the sheetstock layer 21.

A further advantage of the construction 20 of the present disclosure may be an improved depth of image of the reflective metal layer 23. Any coloring or printing applied to the transparent coating layer 22 may also appear to lie deep within the laminate construction 20.

Finally, impact performance of the bright, reflective laminate, particularly at low temperature, may be improved by having the sheetstock layer 21 as the outer layer which receives the impact.

The description and drawings illustratively set forth our presently preferred disclosure embodiments. We intend the description and drawings to describe these embodiments and not to limit the scope of the disclosure. Those skilled in the art will appreciate that still other modifications and variations of the present disclosure are possible in light of the above teaching while remaining within the scope of the following claims. Therefore, within the scope of the claims, one may practice the disclosure otherwise than as the description and drawings specifically show and describe.

What is claimed is:

1. A metallized article comprising:
a substrate capable of transmitting light and having a first and second surface;
a polyurethane topcoat disposed on said second surface;
a layer of electrically discrete metallic islands of a corrosion prone metal disposed upon said topcoat; and
a polyurethane basecoat disposed upon said layer of electrically discrete metallic islands of a corrosion prone metal.

2. The metallized article of claim 1 wherein said article comprises a sheetstock

3. The metallized article of claim 1 wherein said basecoat at least partially encapsulates said electrically discrete metallic islands.
